(19) United States
(12) Patent Application Publication
(10) Pub. No.: US 2014/0286438 A1
(43) Pub. Date: Sep. 25, 2014

(54) QUALITY OF SERVICE MANAGEMENT SERVER AND METHOD OF MANAGING STREAMING BIT RATE

(71) Applicant: NVIDIA CORPORATION, Santa Clara, CA (US)

(72) Inventor: Atul Apte, Santa Clara, CA (US)

(73) Assignee: Nvidia Corporation, Santa Clara, CA (US)

(21) Appl. No.: 13/847,037

(22) Filed: Mar. 19, 2013

(51) Int. Cl. H04N 7/26

(52) U.S. Cl. CPC H04N 19/00545
USPC 375/240.26

(57) ABSTRACT

A quality of service (QoS) management server and a method of managing a streaming bit rate. One embodiment of a QoS management server includes: (1) an encoder operable to encode a video stream at a current bit rate for transmission via a network interface controller (NIC) and (2) a processor operable to receive QoS statistics regarding the video stream via the NIC, employ the QoS statistics to determine a new bit rate and cause the encoder to encode the video stream at the new bit rate.

### TECHNICAL FIELD

This application is directed, in general, to cloud gaming and, more specifically, to quality of service (QoS) in the context of cloud gaming.

### BACKGROUND

The utility of personal computing was originally focused at an enterprise level, putting powerful tools on the desktops of researchers, engineers, analysts and typists. That utility has evolved from mere number-crunching and word processing to highly programmable, interactive workpieces capable of production level and real-time graphics rendering for incredibly detailed computer aided design, drafting and visualization. Personal computing has more recently evolved into a key role as a media and gaming outlet, fueled by the development of mobile computing. Personal computing is no longer resigned to the world's desktops, or even laptops. Robust networks and the miniaturization of computing power have enabled mobile devices, such as cellular phones and tablet computers, to carve large swaths out of the personal computing market. Desktop computers remain the highest performing personal computers available and are suitable for traditional businesses, individuals and gamers. However, as the utility of personal computing shifts from pure productivity to envelope media dissemination and gaming, and, more importantly, as media streaming and gaming form the leading edge of personal computing technology, a dichotomy develops between the processing demands for “everyday” computing and those for high-end gaming, or, more generally, for high-end graphics rendering.

The processing demands for high-end graphics rendering drive development of specialized hardware, such as graphics processing units (GPUs) and graphics processing systems (graphics cards). For many users, high-end graphics hardware would constitute a gross under-utilization of processing power. The rendering bandwidth of high-end graphics hardware is simply lost on traditional productivity applications and media streaming. Cloud graphics processing is a centralization of graphics rendering resources aimed at overcoming the developing misallocation.

In cloud architectures, similar to conventional media streaming, graphics content is stored, retrieved and rendered on a server where it is then encoded, packetized and transmitted over a network to a client as a video stream (often including audio). The client simply decodes the video stream and displays the content. High-end graphics hardware is thereby obviated on the client end, which requires only the ability to play video. Graphics processing servers centralize high-end graphics hardware, enabling the pooling of graphics rendering resources where they can be allocated appropriately upon demand. Furthermore, cloud architectures pool storage, security and maintenance resources, which provide users easier access to more up-to-date content than can be had on traditional personal computers.

Perhaps the most compelling aspect of cloud architectures is the inherent cross-platform compatibility. The corollary to centralizing graphics processing is offloading large complex rendering tasks from client platforms. Graphics rendering is often carried out on specialized hardware executing proprietary procedures that are optimized for specific platforms running specific operating systems. Cloud architectures need only a thin-client application that can be easily portable to a variety of client platforms. This flexibility on the client side lends itself to content and service providers who can now reach the complete spectrum of personal computing consumers operating under a variety of hardware and network conditions.

### SUMMARY

One aspect provides a QoS management server. In one embodiment, the server includes: (1) an encoder operable to encode a video stream at a current bit rate for transmission via a network interface controller (NIC) and (2) a processor operable to receive QoS statistics regarding the video stream via the NIC, employ the QoS statistics to determine a new bit rate and cause the encoder to encode the video stream at the new bit rate.

Another aspect provides a method of managing a streaming bit rate. In one embodiment, the method includes: (1) receiving QoS statistics regarding transmitted frames of a video stream encoded at a current bit rate, (2) dividing a bit rate range into intermediate retracement levels, and (3) gradually increasing the streaming bit rate from the current bit rate through the intermediate retracement levels if the QoS statistics indicate network bandwidth could be available.

Yet another aspect provides a QoS management server. In one embodiment, the server includes: (1) a GPU having an encoder configured to encode frames of a video stream at a bit rate, (2) a NIC configured to transmit the frames toward a client and receive QoS statistics regarding the transmitted frames, and (3) a central processing unit (CPU) configured to: (3a) accumulate a count of consecutive frames experiencing zero packet loss, (3b) initiate a step increase in the bit rate if the count exceeds a zero-loss threshold, and (3c) initiate a step decrease in the bit rate if the transmitted frames experienced packet loss above a loss threshold.

### BRIEF DESCRIPTION

Reference is now made to the following descriptions taken in conjunction with the accompanying drawings, in which:

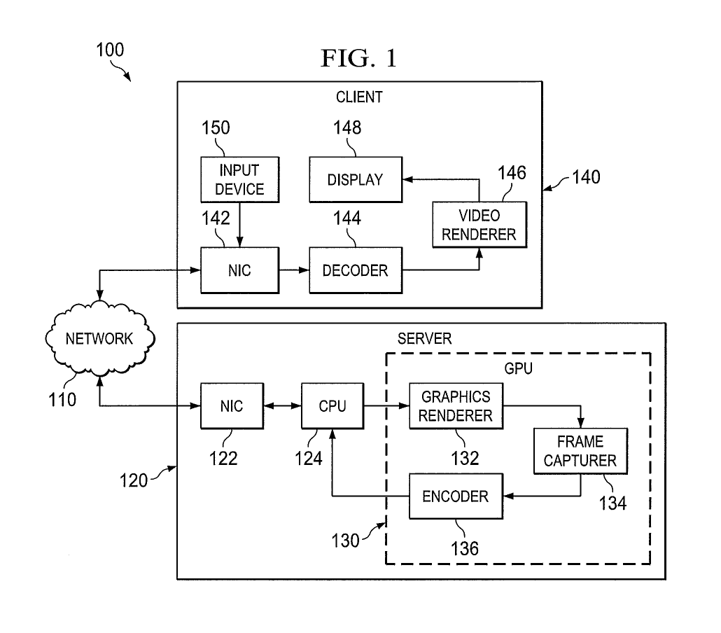

FIG. 1 is a block diagram of a cloud gaming system;

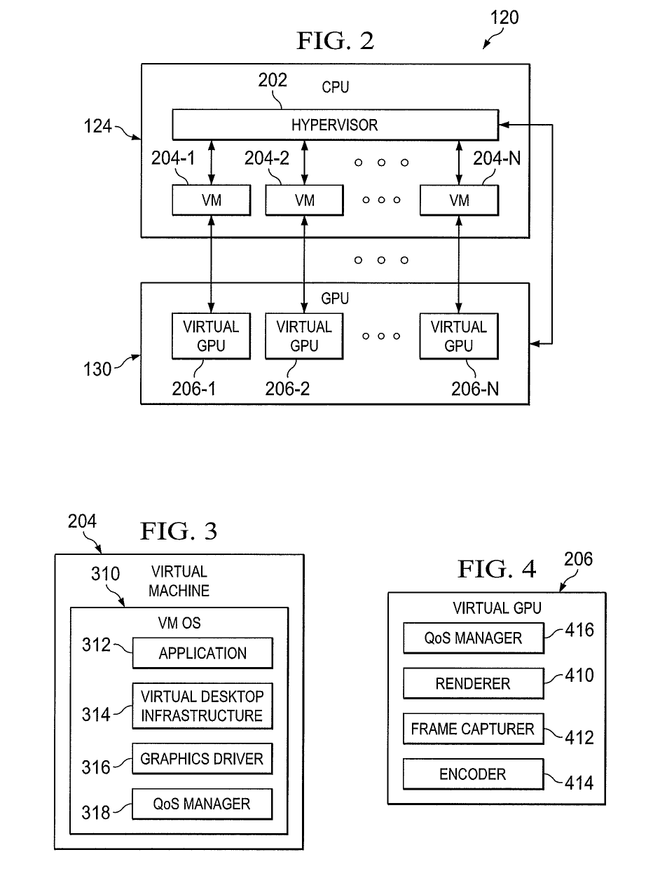

FIG. 2 is a block diagram of a server;

FIG. 3 is a block diagram of one embodiment of a virtual machine;

FIG. 4 is a block diagram of one embodiment of a virtual GPU; and

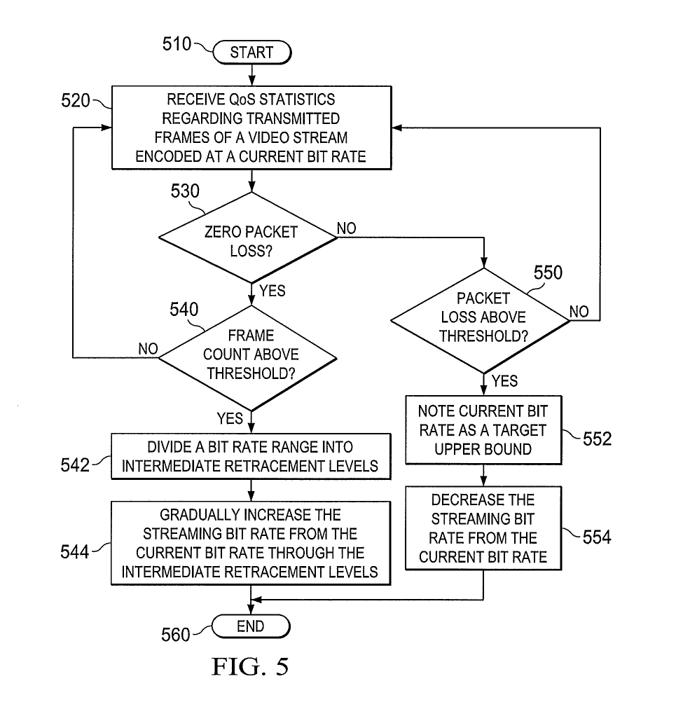

FIG. 5 is a flow diagram of one embodiment of a method of managing streaming bit rate.

### DETAILED DESCRIPTION

Major limitations of cloud gaming, and cloud graphics processing in general, are latency and the unpredictable network conditions that bring it about. Latency in cloud gaming can be devastating to game play experience. Latency in simple media streaming is less catastrophic because it may be counteracted by pre-encoding the streaming media, buffering the stream on the receiving end, or both. By its nature, cloud gaming employs a significant real-time interactive component in which a user's input closes the loop among the server, client and the client's display. The lag between the user's input and visualizing the resulting effect is considered latency. It is realized herein that pre-encoding or buffering does nothing to address this latency.

Latency is induced by a variety of network conditions, including: network bandwidth constraints and fluctuations, packet loss over the network, increases in packet delay and fluctuations in packet delay from the server to the client, which manifest on the client as jitter. While latency is an important aspect of the game play experience, the apparent fidelity of the video stream to the client is plagued by the same network conditions. Fidelity is a measure of the degree to which a displayed image or video stream corresponds to the ideal. An ideal image mimics reality; its resolution is extremely high, and it has no compression, rendering or transmission artifacts. An ideal video stream is a sequence of ideal images presented with no jitter and at a frame rate so high that it, too, mimics reality. Thus, a higher-resolution, higher-frame-rate, less-artifacted, lower-jitter video stream has a higher fidelity than one that has lower resolution, a lower frame rate, contains more artifacts or is more jittered.

Latency and fidelity are essentially the client's measures of the game play experience. However, from the perspective of the server or a cloud service provider, the combination of latency and fidelity are components of QoS. A QoS system, often taking the form of a server, is tasked with managing QoS for its clients. The goal is to ensure an acceptable level of latency and fidelity, the game play experience, is maintained under whatever network conditions arise and for whatever client device subscribes to the service.

The management task involves collecting network data and evaluating the network conditions between the server and client. Traditionally, the client performs that evaluation and dictates back to the server the changes to the video stream it desires. It is realized herein that a better approach is to collect the network data, or “QoS statistics,” on the client and transmit it to the server so the server can evaluate and determine how to improve QoS. Given that the server executes the application, renders, captures, encodes and transmits the video stream to the client, it is realized herein the server is better suited to perform QoS management. It is also realized herein the maintainability of the QoS system is simplified by shifting the task to the server because QoS software and algorithms are centrally located on the server, and the client need only remain compatible, which should include continuing to transmit QoS statistics to the server.

The client is capable of collecting a variety of QoS statistics. One example is packets lost, or packet loss count. The server marks packets with increasing packet numbers. When the client receives packets, it checks the packet numbers and determines how many packets were lost. The packet loss count is accumulated until QoS statistics are ready to be sent to the server. A corollary to the packet loss count is the time interval over which the losses were observed. The time interval is sent with the QoS statistics, to the server, which can calculate a packet loss rate. Meanwhile, the client resets the count and begins accumulating again.

Another example of a QoS statistic is a one-way-delay. When a packet is ready to transmit, the server writes the transmit timestamp in the packet header. When the packet is received by the client, the receipt timestamp is noted. The time difference is the one-way-delay. Since clocks on the server and client are not necessarily synchronized, the one-way-delay value is not the same as the packet transmit time. So, as the client accumulates one-way-delay values for consecutive packets and transmits them to the server, the server calculates one-way-delay deltas between consecutive packets. The deltas give the server an indication of changes in latency.

Yet another example of a QoS statistic is a frame number. Frame numbers are embedded in each frame of video. When the client sends statistics to the server, it includes the frame number of the frame being processed by the client at that time. From this, the server can determine the speed at which the client is able to process the video stream, which is to say, the speed at which the client receives, unpacks, decodes and renders for display.

QoS statistics are sent periodically to the server for use in QoS determinations. It is realized herein the frequency at which the client sends QoS statistics is itself an avenue of tuning QoS to that client. Another example of a QoS setting, realized herein, is controlling the streaming bit rate. The streaming bit rate is basically the rate at which data is transmitted to the client. Increasing the bit rate consumes more network bandwidth and increases the processing load on the client. Conversely, decreasing the bit rate relieves the network and the client, generally at the cost of fidelity.

Some systems periodically write a large amount of data over the network to gauge the network bandwidth, but this can make bad network conditions worse. Other systems use pre-encoding and provide clients the option to stream a particular segment of video at various bit rates according to how the client perceives network conditions. Pre-encoding, however, as mentioned above, is unavailable for real-time interactive applications.

It is realized herein that certain conventional real-time adaptive bit rate algorithms are subject to thrashing, or over-actively adjusting the bit rate as a reaction to constantly changing network conditions. Other conventional algorithms, such as those in non-real-time video streaming, use buffering or pre-encoding to mitigate network conditions, both of which are unavailable for real-time applications. An inability to recognize network condition improvements leads to sustained poor quality, while changing the bit rate too fast (thrashing) leads to over corrections and fluctuations in perceived fidelity. The QoS statistics most useful for controlling the bit rate are the packet loss count and one-way-delay times. From the packet loss count and the current bit rate, the server can estimate a packet loss rate. If the rate is zero, no packets were lost. If the rate is above zero, packet loss is occurring and it may indicate the server is transmitting too many bits over the channel. Similarly, if one-way-delay deltas are increasing, this may also indicate the server is transmitting too many bits over the channel. In both cases, a decrease in the bit rate is warranted until the packet losses and one-way-delay delta times drop to zero.

It is further realized herein that packet loss counts and one-way-delay times are insufficient by themselves for determining when to increase the bit rate. If packet loss and one-way-delay deltas are low, it is possible the reduced bit rate is simply holding transmissions below the network bandwidth threshold. In that case, it is realized herein that increasing the bit rate too quickly will result in a nearly immediate need to lower it again, which manifests as a fluctuations in fidelity and a “stuttering” playback. Another possibility is that network conditions have in fact improved and the current bit rate is holding transmissions well below the network bandwidth. It is realized herein that withholding bit rate increases altogether yields a QoS that is less than optimal.

It is realized herein the server can mitigate these issues by gradually adjusting the bit rate according to the QoS statistics fed back from the client. It is also realized herein the use of a configurable rate gain multiplier and rate drop multiplier, and a zero-loss threshold allow improved control of the bit rate. The rate gain multiplier is the basis for the gradual step size of bit rate increases. The rate drop multiplier is the basis for the step size of bit rate decreases. The zero-loss threshold enforces a configurable minimum number of frames that must experience zero packet loss before the video stream is eligible for a bit rate increase, thereby regulating the frequency at which bit rate increases can be made. Additionally, a particular client may enforce configurable minimum and maximum bit rates.

When an increase in bit rate is warranted, a range is defined by the current bit rate and the next target upper bound. Several target upper bounds may exist, for example: a maximum bit rate, an initial bit rate or a resistance level bit rate. The bit rate range is divided into intermediate “retracement” levels that divide the range into a plurality of more moderate stepwise increases in bit rate. For instance, if the range is divided into three intermediate retracement levels, the bit rate is stepped up according to the rate gain multiplier and the zero-loss threshold. The bit rate is stepped up through and past each of the three intermediate retracement levels until the target upper bound is reached. At that point, assuming the zero-loss threshold is still met, a new range is defined from that bit rate up to the next target upper bound. The retracement levels serve as guideposts for further adjustments.

If at some point losses or latencies resume, the current bit rate is marked as a resistance level target upper bound and the bit rate is gradually decreased. Future bit rate increases will approach that resistance level more conservatively.

Additionally, it is realized herein that a variety of avenues, or QoS settings, for tuning QoS are possible, including: minimum and maximum bit rates, minimum and maximum capture frame rates, the frequency of bit rate changes and hysteresis in buffering thresholds.

Before describing various embodiments of the QoS system or method introduced herein, a cloud gaming environment within which the system or method may be embodied or carried out will be described.

FIG. 1 is a block diagram of a cloud gaming system 100. Cloud gaming system 100 includes a network 110 through which a server 120 and a client 140 communicate. Server 120 represents the central repository of gaming content, processing and rendering resources. Client 140 is a consumer of that content and those resources. Server 120 is freely scalable and has the capacity to provide that content and those services to many clients simultaneously by leveraging parallel and apportioned processing and rendering resources. The scalability of server 120 is limited by the capacity of network 110 in that above some threshold of number of clients, scarcity of network bandwidth requires that service to all clients degrade on average.

Server 120 includes a network interface card (NIC) 122, a central processing unit (CPU) 124 and a GPU 130. Upon request from Client 140, graphics content is recalled from memory via an application executing on CPU 124. As is convention for graphics applications, games for instance, CPU 124 reserves itself for carrying out high-level operations, such as determining position, motion and collision of objects in a given scene. From these high level operations, CPU 124 generates rendering commands that, when combined with the scene data, can be carried out by GPU 130. For example, rendering commands and data can define scene geometry, lighting, shading, texturing, motion, and camera parameters for a scene.

GPU 130 includes a graphics renderer 132, a frame capturer 134 and an encoder 136. Graphics renderer 132 executes rendering procedures according to the rendering commands generated by CPU 124, yielding a stream of frames of video for the scene. Those raw video frames are captured by frame capturer 134 and encoded by encoder 136. Encoder 134 formats the raw video stream for transmission, possibly employing a video compression algorithm such as the H.264 standard arrived at by the International Telecommunication Union Telecommunication Standardization Sector (ITU-T) or the MPEG-4 Advanced Video Coding (AVC) standard from the International Organization for Standardization/International Electrotechnical Commission (ISO/IEC). Alternatively, the video stream may be encoded into Windows Media Video® (WMV) format, VP8 format, or any other video encoding format.

CPU 124 prepares the encoded video stream for transmission, which is passed along to NIC 122. NIC 122 includes circuitry necessary for communicating over network 110 via a networking protocol such as Ethernet, Wi-Fi or Internet Protocol (IP). NIC 122 provides the physical layer and the basis for the software layer of server 120's network interface.

Client 140 receives the transmitted video stream for display. Client 140 can be a variety of personal computing devices, including: a desktop or laptop personal computer, a tablet, a smart phone or a television. Client 140 includes a NIC 142, a decoder 144, a video renderer 146, a display 148 and an input device 150. NIC 142, similar to NIC 122, includes circuitry necessary for communicating over network 110 and provides the physical layer and the basis for the software layer of client 140's network interface. The transmitted video stream is received by client 140 through NIC 142. Client 140 can employ NIC 142 to collect QoS statistics based on the received video stream, including packet loss and one-way-delay.

The video stream is then decoded by decoder 144. Decoder 144 should match encoder 136, in that each should employ the same formatting or compression scheme. For instance, if encoder 136 employs the ITU-T H.264 standard, so should decoder 144. Decoding may be carried out by either a client CPU or a client GPU, depending on the physical client device. Once decoded, all that remains in the video stream are the raw rendered frames. The rendered frames a processed by a basic video renderer 146, as is done for any other streaming media. The rendered video can then be displayed on display 148.

An aspect of cloud gaming that is distinct from basic media streaming is that gaming requires real-time interactive streaming. Not only must graphics be rendered, captured and encoded on server 120 and routed over network 110 to client 140 for decoding and display, but user inputs to client 140 must also be relayed over network 110 back server 120 and processed within the graphics application executing on CPU 124. This real-time interactive component of cloud gaming limits the capacity of cloud gaming systems to “hide” latency.

Client 140 periodically sends QoS statistics back to Server 120. When the QoS statistics are ready to be sent, Client 140 includes the frame number of the frame of video being rendered by video renderer 146. The frame number is useful for server 120 to determine how well network 110 and client 140 are handling the video stream transmitted from server 120. Server 120 can then use the QoS statistics to determine what actions in GPU 130 can be taken to improve QoS. Actions available to GPU 130 include: adjusting the resolution at which graphics renderer 132 renders, adjusting the capture frame rate at which frame capturer 134 operates and adjusting the bit rate at which encoder 136 encodes.

FIG. 2 is a block diagram of server 120 of FIG. 1. This aspect of server 120 illustrates the capacity of server 120 to support multiple simultaneous clients. In FIG. 2, CPU 124 and GPU 130 of FIG. 1 are shown. CPU 124 includes a hypervisor 202 and multiple virtual machines (VMs), VM 204-1 through VM 204-N. Likewise, GPU 130 includes multiple virtual GPUs, virtual GPU 206-1 through virtual GPU 206-N. In FIG. 2, server 120 illustrates how N clients are supported. The actual number of clients supported is a function of the number of users ascribing to the cloud gaming service at a particular time. Each of VM 204-1 through VM 204-N is dedicated to a single client desiring to run a respective gaming application. Each of VM 204-1 through VM 204-N executes the respective gaming application and generates rendering commands for GPU 130. Hypervisor 202 manages the execution of the respective gaming application and the resources of GPU 130 such that the numerous users share GPU 130. Each of VM 204-1 through VM 204-N respectively correlates to virtual GPU 206-1 through virtual GPU 206-N. Each of the virtual GPU 206-1 through virtual GPU 206-N receives its respective rendering commands and renders a respective scene. Each of virtual GPU 206-1 through virtual GPU 206-N then captures and encodes the raw video frames. The encoded video is then streamed to the respective clients for decoding and display.

Having described a cloud gaming environment in which the QoS system and method introduced herein may be embodied or carried out, various embodiments of the system and method will be described.

FIG. 3 is a block diagram of virtual machine (VM) 204 of FIG. 2. VM 204 includes a VM operating system (OS) 310 within which an application 312, a virtual desktop infrastructure (VDI) 314, a graphics driver 316 and a QoS manager 318 operate. VM OS 310 can be any operating system on which available games are hosted. Popular VM OS 310 options include: Windows®, iOS®, Android®, Linux and many others. Within VM OS 310, application 312 executes as any traditional graphics application would on a simple personal computer. The distinction is that VM 204 is operating on a CPU in a server system (the cloud), such as server 120 of FIG. 1 and FIG. 2. VDI 314 provides the foundation for separating the execution of application 312 from the physical client desiring to gain access. VDI 314 allows the client to establish a connection to the server hosting VM 204. VDI 314 also allows inputs received by the client, including through a keyboard, mouse, joystick, hand-held controller, or touchscreens, to be routed to the server, and outputs, including video and audio, to be routed to the client. Graphics driver 316 is the interface through which application 312 can generate rendering commands that are ultimately carried out by a GPU, such as GPU 130 of FIG. 1 and FIG. 2 or virtual GPUs, virtual GPU 206-1 through virtual GPU 206-N.

QoS manager 318 receives QoS statistics transmitted from a particular client, such as client 140, and determines how to configure various QoS settings for that client. The various QoS settings influence the perceived fidelity of the video stream and, consequently, the latency. The various QoS settings generally impact the streaming bit rate, capture frame rate and resolution; however, certain QoS settings are more peripheral, including: the frequency of QoS statistic transmissions, the frequency of bit rate changes and the degree of hysteresis in the various thresholds. One group of QoS settings relate to the streaming bit rate. QoS manager 318 employs QoS statistics, such as the packet loss count and one-way-delay times, to determine whether a bit rate increase or decrease is warranted. QoS manager 318 has further control over the frequency and magnitude of bit rate changes via a zero-loss threshold and rate gain multiplier, respectively.

Once determined, QoS manager 318 implements configuration changes by directing the GPU accordingly. The GPU includes an encoder that is capable of encoding at a configurable bit rate, as does GPU 130. Alternatively, the QoS manager tasks can be carried out on the GPU itself, such as GPU 130.

FIG. 4 is a block diagram of virtual GPU 206 of FIG. 2. Virtual GPU 206 includes a renderer 410, a framer capturer 412, an encoder 414 and a QoS manager 416. Virtual GPU 206 is responsible for carrying out rendering commands for a single virtual machine, such as VM 204 of FIG. 3. Rendering is carried out by renderer 410 and yields raw video frames having a resolution. The raw frames are captured by frame capturer 412 at a capture frame rate and then encoded by encoder 414. The encoding can be carried out at various bit rates and can employ a variety of formats, including H.264 or MPEG4 AVC. The inclusion of an encoder in the GPU, and, moreover, in each virtual GPU 206, reduces the latency often introduced by dedicated video encoding hardware or CPU encoding processes.

Similar to QoS manager 318 of FIG. 3, QoS manager 416 receives QoS statistics from the client and determines how to configure various QoS settings for the client, including how to encode the bit stream. Unlike the embodiment of FIG. 3, the inclusion of QoS manager 416 within virtual GPU 206 allows more direct control over the elements of each virtual GPU, including renderer 410, frame capturer 412 and encoder 414. These elements are largely responsible for implementing the various QoS settings arrived at by QoS manager 416, or QoS manager 318 of the embodiment of FIG. 3. Certain other QoS settings are originate at the client itself, such as the frequency of QoS statistics transmissions.

FIG. 5 is a flow diagram of one embodiment of a method for managing a streaming bit rate in the context of cloud gaming. The method begins at a start step 510. At a step 520 QoS statistics are received at the server. The QoS statistics could be a variety of data, including a packet loss count and one-way-delay times. The QoS statistics are taken by the client regarding transmitted frames of a video stream. The video stream, which originates at the server, is encoded at a current bit rate.

A determination is made at a step 530 as to whether or not the transmission of frames experience packet loss. Certain embodiments also consider fluctuations in one-way-delay delta times. The determination is based on the QoS statistics received at step 520. If zero packet loss, or in some embodiments, very small packet loss, has been observed, the method proceeds to a step 540 where a count of consecutive frames experiencing zero or very small packet loss is kept. If the count rises above the zero-loss threshold, an increase in the bit rate is initiated. Otherwise, the current bit rate is maintained until the count reaches the zero-loss threshold or packet losses are observed. At a step 542 the range of possible bit rates is defined and divided into intermediate retracement levels. A gradual increase in the bit rate is carried out at a step 544.

If, at determination step 530, zero packet loss is not observed, that is to say the transmission is experiencing packet loss, then a second determination is made at a step 550. If the losses observed rise above a loss threshold, then a decrease in the bit rate is initiated. In alternate embodiments, as mentioned above, fluctuations in one-way-delay delta times combined with packet losses may also trigger a bit rate decrease. Otherwise, the current bit rate is maintained until the packet loss exceeds the loss threshold or the losses are reduced to zero. At a step 552 the current bit rate is noted as a target upper bound bit rate so that future bit rate increases will approach that level more conservatively. The bit rate is then decreased at a step 554.

Certain embodiments of the method repetitively apply this procedure to gradually move the bit rate from the current rate, through the intermediate retracement levels and up to the target upper bound. In these embodiments, each step up and step down in bit rate is scaled by the configurable rate gain multiplier and rate drop multiplier, respectively, and is predicated on the respective zero-loss threshold or loss threshold being met. The method then ends at a step 560.

Those skilled in the art to which this application relates will appreciate that other and further additions, deletions, substitutions and modifications may be made to the described embodiments.

What is claimed is:

1. A quality of service (QoS) management server, comprising:
an encoder operable to encode a video stream at a current bit rate for transmission via a network interface controller (NIC); and
a processor operable to receive QoS statistics regarding said video stream via said NIC, employ said QoS statistics to determine a new bit rate and cause said encoder to encode said video stream at said new bit rate.

2. The QoS management server recited in claim 1 wherein said QoS statistics include a packet loss count and one-way-delay values from a client.

3. The QoS management server recited in claim 1 wherein said new bit rate is:
an increased bit rate relative to said current bit rate if said QoS statistics indicate network bandwidth could be available; and
a decreased bit rate relative to said current bit rate if said QoS statistics indicate insufficient network bandwidth to support said current bit rate.

4. The QoS management server recited in claim 3 wherein said processor is further operable to employ a configurable rate gain multiplier on which said increased bit rate is based.

5. The QoS management server recited in claim 4 wherein said configurable rate gain multiplier influences a bit rate increment between successive bit rate increases.

6. The QoS management server recited in claim 4 wherein said processor is configured to:
determine a range of bit rates bound by said current bit rate and a target upper bound bit rate;
divide said range into intermediate retracement levels; and
schedule bit rate increases throughout said intermediate retracement levels according to said configurable rate gain multiplier.

7. The QoS management server recited in claim 1 wherein said processor is further operable to employ a configurable zero-loss threshold as a pre-requisite for a bit rate increase.

8. A method of managing a streaming bit rate, comprising:
receiving quality of service (QoS) statistics regarding transmitted frames of a video stream encoded at a current bit rate;
dividing a bit rate range into intermediate retracement levels; and
gradually increasing said streaming bit rate from said current bit rate through said intermediate retracement levels if said QoS statistics indicate network bandwidth could be available.

9. The method recited in claim 8 further comprising:
encoding rendered frames of said video stream at said streaming bit rate; and
transmitting the encoded frames towards a client.

10. The method recited in claim 8 wherein said receiving includes:
receiving a packet loss count with respect to a time interval; and
receiving one-way-delay time values between consecutive packets.

11. The method recited in claim 10 further comprising:
counting consecutive frames experiencing zero packet loss; and
initiating an increase in said streaming bit rate.

12. The method recited in claim 8 wherein said gradually increasing includes employing a configurable rate gain multiplier to determine a step size for said gradually increasing.

13. The method recited in claim 8 wherein said bit rate range is bound by said current bit rate and a target upper bound bit rate.

14. The method recited in claim 13 further comprising: noting said current bit rate as a target upper bound bit rate and decreasing said streaming bit rate until said QoS statistics indicate network bandwidth is available, if said QoS statistics indicate said current bit rate exceeds available network bandwidth.

15. A quality of service (QoS) management server, comprising:
a graphics processing unit (GPU) having an encoder configured to encode frames of a video stream at a bit rate;
a network interface controller (NIC) configured to transmit said frames toward a client and receive QoS statistics regarding the transmitted frames; and
a central processing unit (CPU) configured to:
accumulate a count of consecutive frames experiencing zero packet loss,
initiate a step increase in said bit rate if said count exceeds a zero-loss threshold, and
initiate a step decrease in said bit rate if the transmitted frames experienced packet loss above a loss threshold.

16. The QoS management server recited in claim 15 wherein said step increase is based on a configurable rate gain multiplier that controls the step size of said step increase.

17. The QoS management server recited in claim 15 wherein said step decrease is based on a configurable rate drop multiplier that controls the step size of said step decrease.

18. The QoS management server recited in claim 15 wherein said zero-loss threshold is configurable.

19. The QoS management server recited in claim 15 wherein said encoder is prohibited from encoding above a configurable maximum bit rate.

20. The QoS management server recited in claim 15 wherein said QoS statistics include:
a packet loss count; and
one-way-delay time values between consecutive packets of the transmitted frames.
